(19) United States
(12) Patent Application Publication
(10) Pub. No.: US 2026/0129570 A1
(43) Pub. Date: May 7, 2026

(54) Selection of Cell for Network Access in Cell Delegation Scenario

(71) Applicant: Telefonaktiebolaget LM Ericsson (publ), Stockholm (SE)

(72) Inventors: Rui Fan, Beijing (CN); Pål Frenger, Linköping (SE); Ali Nader, Malmö (SE); Nianshan Shi, Järfälla (SE); Sina Maleki, Malmö (SE)

(21) Appl. No.: 19/117,580

(22) PCT Filed: Oct. 9, 2023
(86) PCT No.: PCT/CN2023/123516

§ 371 Date: Apr. 1, 2025

(30) Foreign Application Priority Data
Nov. 4, 2022 (WO) PCT/CN2022/129835

(51) Int. Cl. H04W 48/20; H04W 48/10; H04W 74/00; H04W 74/0833

(52) U.S. Cl. CPC H04W 48/20; H04W 48/10; H04W 74/006; H04W 74/0833

(57) ABSTRACT

The present disclosure is related to a UE, a network node, and methods for selecting a cell for network access in a cell delegation scenario. A method at a terminal device for selecting a cell for network access comprises: receiving one or more messages and/or signals indicating one or more configurations for selecting a cell; and selecting a cell from multiple cells comprising a first cell and one or more second cells based on at least the one or more configurations, wherein at least a part of transmission associated with the one or more second cells is delegated to the first cell.

### CROSS-REFERENCE TO RELATED APPLICATION(S)

This application claims priority to the PCT International Application No. PCT/CN2022/129835, entitled “SELECTION OF CELL FOR NETWORK ACCESS IN CELL DELEGATION SCENARIO”, filed on Nov. 4, 2022, which is incorporated herein by reference in its entirety.

### TECHNICAL FIELD

The present disclosure is related to the field of telecommunication, and in particular, to a User Equipment (UE), a network node, and methods for selecting a cell for network access in a cell delegation scenario.

### BACKGROUND

With the development of the electronic and telecommunication technologies, mobile devices, such as mobile phones, smart phones, laptops, tablets, vehicle mounted devices, become an important part of our daily lives. To support a numerous number of mobile devices, a highly efficient Radio Access Network (RAN), such as a fifth generation (5G) New Radio (NR) RAN, will be required.

Carriers have been looking at energy efficiency for a few years now, but 5G will bring this to top of mind because it is going to use more energy than 4G. Some carriers spend on average 5% to 6% of their operating expenses, excluding depreciation and amortization, on energy costs, and this is expected to rise with the shift from 4G to 5G.

A typical 5G base station consumes up to twice or more the power of a 4G base station, and energy costs can grow even more at higher frequencies, due to a need for more antennas and a denser layer of small cells. Edge computing facilities needed to support local processing and new internet of things (IoT) services will also add to overall network power usage.

According to data on Remote Radio Unit (RRU)/Baseband Unit (BBU) needs per site, a typical 5G site has power needs of over 11.5 kilowatts, up nearly 70% from a base station deploying a mix of 2G, 3G, and 4G radios. 5G macro base stations may require several new, power-hungry components, including microwave or millimeter wave transceivers, field-programmable gate arrays (FPGAs), faster data converters, high-power/low-noise amplifiers and integrated Multiple-Input-Multiple-Output (MIMO) antennas.

The increased power demands of a 5G base station can create several problems:
Insufficient alternating current (AC) power supply;
Insufficient battery capacity: more backup battery capacity is needed, yet traditional lead-acid batteries have low energy density and their capacities are difficult to expand;
Unable to support high-power long-distance transmission: in 5G scenarios requiring high power supply to remote active antenna units (AAUs), the voltage drop means that transmission distance is limited.

### SUMMARY

According to a first aspect of the present disclosure, a method at a terminal device for selecting a cell for network access is provided. The method comprises: receiving one or more messages and/or signals indicating one or more configurations for selecting a cell; and selecting a cell from multiple cells comprising a first cell and one or more second cells based on at least the one or more configurations, wherein at least a part of transmission associated with the one or more second cells is delegated to the first cell.

In some embodiments, the multiple cells are associated with one or more network nodes. In some embodiments, the part of transmission associated with the one or more second cells is performed in the first cell instead of the one or more second cells, when the part of transmission is delegated to the first cell, and/or the part of transmission associated with the one or more second cells is performed in the one or more second cells, when the part of transmission is not delegated to any cell. In some embodiments, the method further comprises: initiating a random access procedure towards the selected cell.

In some embodiments, before the step of selecting the cell, the method further comprises: receiving, from the first cell, a paging message destined to the terminal device, wherein the step of selecting the cell is performed in response to the step of receiving, from the first cell, a paging message destined to the terminal device. In some embodiments, the one or more messages and/or signals comprise at least one of: a Radio Resource Control (RRC) Master Information Block (MIB) message; an RRC System Information Block 1 (SIB1) message; an RRC System Information (SI) message; an RRC paging message; a Medium Access Control (MAC) Protocol Data Unit (PDU); a MAC Control Element (CE); a paging Physical Downlink Shared Channel (PDSCH); a Physical Downlink Control Channel (PDCCH); a Synchronous Signal and Physical Broadcast Channel Block (SSB); and a Reference Signal (RS).

In some embodiments, for at least one of the second cells, at least one of following is delegated to the first cell: SSB transmission associated with the at least one second cell; SIB1 transmission associated with the at least one second cell; SI transmission associated with the at least one second cell; and paging associated with the at least one second cell. In some embodiments, at least one of the one or more messages is received from at least one of: the first cell; and at least one of the one or more second cells. In some embodiments, the one or more configurations comprise at least one of: a dedicated configuration that is dedicated to the terminal device and indicates towards which cell the terminal device is to initiate a random access procedure; and a broadcast configuration that is broadcast to the terminal device and indicates towards which cell a terminal device is to initiate a random access procedure.

In some embodiments, at least one of the one or more configurations indicates towards which cell the terminal device is to initiate a random access procedure by at least one of: an Information Element (IE); a bitfield; a value tag; and a specific sequence. In some embodiments, when a dedicated configuration for cell selection and a broadcast configuration for cell selection are received by the terminal device, the broadcast configuration is overruled by the dedicated configuration. In some embodiments, when the one or more messages indicate a dedicated configuration, the one or more messages further indicate a validity timer and/or a validity area, such that the dedicated configuration is valid for the terminal device only during a time duration indicated by the validity timer and/or only when the terminal device is located in the validity area. In some embodiments, at least one of the one or more configurations indicates that different cells from the multiple cells are to be selected for access due to different trigger events. In some embodiments, the trigger events comprise at least one of: paging; and terminal device initiated access.

In some embodiments, at least one of the one or more configurations indicates that different cells from the multiple cells are to be selected for access with different establishment causes. In some embodiments, at least one of the one or more configurations indicates that different cells from the multiple cells are to be selected for access with different action purposes. In some embodiments, at least one of the one or more configurations indicates that different cells from the multiple cells are to be selected for access with at least one of different radio bearers, different Quality of Service (QoS) flows, and different 5G QoS Identifiers (5QIs). In some embodiments, at least one of the one or more configurations indicates that different cells from the multiple cells are to be selected for access with different requirements on data exchange. In some embodiments, the different requirements on data exchange comprise at least one of: data exchange rate; and data exchange size.

In some embodiments, when the one or more messages comprise a paging message, the step of selecting the cell comprises: selecting different cells from the multiple cells for access in response to the paging message being encoded with different Radio Network Temporary Identifiers (RNTIs). In some embodiments, when the one or more messages comprise a paging message, a configuration for cell selection indicated by the paging message overrides any other configuration for cell selection that is received prior to the paging message. In some embodiments, when the one or more messages comprise a paging message, a configuration for cell selection indicated by the paging message explicitly indicates towards which cell a random access procedure is to be initiated by the terminal device, wherein the step of selecting the cell comprises: selecting the cell indicated by the paging message. In some embodiments, when the one or more messages comprise a paging message, a configuration for cell selection indicated by the paging message indicates whether the first cell or one of the second cells is to be selected for access, wherein the step of selecting the cell comprises at least one of: selecting the first cell in response to the paging message indicating that the first cell is to be selected; and selecting one of the second cells in response to the paging message indicating that one of the second cells is to be selected for access. In some embodiments, the step of selecting one of the second cells comprises: randomly selecting one of the second cells. In some embodiments, the one or more messages comprise a PDCCH scheduling a short message. In some embodiments, when an indicator indicating that a part of transmission associated with a second cell is delegated to the second cell itself is transmitted or received, the indicator indicates that the part of transmission is not delegated to any cell.

According to a second aspect of the present disclosure, a terminal device is provided. The terminal device comprises: a processor; a memory storing instructions which, when executed by the processor, cause the processor to perform any of the methods of the first aspect.

According to a third aspect of the present disclosure, a terminal device for selecting a cell for network access is provided. The terminal device comprises: a receiving module configured to receive one or more messages and/or signals indicating one or more configurations for selecting a cell; and a selecting module configured to select a cell from multiple cells comprising a first cell and one or more second cells based on at least the one or more configurations, wherein at least a part of transmission associated with the one or more second cells is delegated to the first cell. In some embodiments, the terminal device comprises one or more further modules, each of which may perform any of the methods of the first aspect.

According to a fourth aspect of the present disclosure, a method at a network node for facilitating a terminal device in selecting a cell for network access is provided. The method comprises: transmitting one or more messages and/or signals indicating one or more configurations for selecting a cell to enable the terminal device to select a cell from multiple cells comprising a first cell and one or more second cells based on at least the one or more configurations, wherein at least a part of transmission associated with the one or more second cells is delegated to the first cell.

In some embodiments, the multiple cells are associated with one or more network nodes comprising the network node. In some embodiments, the part of transmission associated with the one or more second cells is performed in the first cell instead of the one or more second cells, when the part of transmission is delegated to the first cell, and/or wherein the part of transmission associated with the one or more second cells is performed in the one or more second cells, when the part of transmission is not delegated to any cell. In some embodiments, the method further comprises: receiving, from the terminal device, a Physical Random Access Channel (PRACH) transmission for the selected cell. In some embodiments, before the step of receiving, from the terminal device, the PRACH transmission, the method further comprises: transmitting, to the terminal device, a paging message, wherein the step of receiving, from the terminal device, the PRACH transmission is performed in response to the step of transmitting, to the terminal device, a paging message.

In some embodiments, the one or more messages and/or signals comprise at least one of: a Radio Resource Control (RRC) Master Information Block (MIB) message; an RRC System Information Block 1 (SIB1) message; an RRC System Information (SI) message; an RRC paging message; a Medium Access Control (MAC) Protocol Data Unit (PDU); a MAC CE; a paging Physical Downlink Shared Channel (PDSCH); a Physical Downlink Control Channel (PDCCH); a Synchronous Signal and Physical Broadcast Channel Block (SSB); and a Reference Signal (RS). In some embodiments, for at least one of the second cells, at least one of following is delegated to the first cell: SSB transmission associated with the at least one second cell; SIB1 transmission associated with the at least one second cell; SI transmission associated with the at least one second cell; and paging associated with the at least one second cell.

In some embodiments, the network node serves at least one of: the first cell; and at least one of the one or more second cells. In some embodiments, the one or more configurations comprise at least one of: a dedicated configuration that is dedicated to the terminal device and indicates towards which cell the terminal device is to initiate a random access procedure; and a broadcast configuration that is broadcast to the terminal device and indicates towards which cell a terminal device is to initiate a random access procedure. In some embodiments, at least one of the one or more configurations indicates towards which cell the terminal device is to initiate a random access procedure by at least one of: an Information Element (IE); a bitfield; a value tag; and a specific sequence. In some embodiments, when a dedicated configuration for cell selection and a broadcast configuration for cell selection are transmitted to the terminal device, the broadcast configuration is overruled by the dedicated configuration.

In some embodiments, when the one or more messages indicate a dedicated configuration, the one or more messages further indicate a validity timer and/or a validity area, such that the dedicated configuration is valid for the terminal device only during a time duration indicated by the validity timer and/or only when the terminal device is located in the validity area. In some embodiments, at least one of the one or more configurations indicates that different cells from the multiple cells are to be selected by the terminal device for access due to different trigger events. In some embodiments, the trigger events comprise at least one of: paging; and terminal device initiated access.

In some embodiments, at least one of the one or more configurations indicates that different cells from the multiple cells are to be selected by the terminal device for access with different establishment causes. In some embodiments, at least one of the one or more configurations indicates that different cells from the multiple cells are to be selected by the terminal device for access with different action purposes. In some embodiments, at least one of the one or more configurations indicates that different cells from the multiple cells are to be selected by the terminal device for access with at least one of different radio bearers, different Quality of Service (QoS) flows, and different 5G QoS Identifiers (5QIs). In some embodiments, at least one of the one or more configurations indicates that different cells from the multiple cells are to be selected by the terminal device for access with different requirements on data exchange. In some embodiments, the different requirements on data exchange comprise at least one of: data exchange rate; and data exchange size.

In some embodiments, when the one or more messages comprise a paging message, a configuration for cell selection indicated by the paging message indicates that different cells from the multiple cells are to be selected by the terminal device based on at least different Radio Network Temporary Identifiers (RNTIs), with which the paging message is encoded. In some embodiments, when the one or more messages comprise a paging message, a configuration for cell selection indicated by the paging message overrides any other configuration for cell selection that is transmitted prior to the paging message. In some embodiments, when the one or more messages comprise a paging message, a configuration for cell selection indicated by the paging message explicitly indicates towards which cell a random access procedure is to be initiated by the terminal device, wherein the step of receiving the PRACH transmission for the selected cell comprises: receiving, from the terminal device, the PRACH transmission for the cell indicated by the paging message.

In some embodiments, when the one or more messages comprise a paging message, a configuration for cell selection indicated by the paging message indicates whether the first cell or one of the second cells is to be selected by the terminal device for access, wherein the step of receiving the PRACH transmission for the selected cell comprises at least one of: receiving, from the terminal device, the PRACH transmission for the first cell in response to the paging message indicating that the first cells is to be selected by the terminal device for access; and receiving, from the terminal device, the PRACH transmission for one of the second cells in response to the paging message indicating that one of the second cells is to be selected by the terminal device for access. In some embodiments, the second cell, for which the PRACH transmission is received, is randomly selected from the one or more second cells.

In some embodiments, the one or more messages comprise a PDCCH scheduling a short message. In some embodiments, when the one or more second cells are served by the network node, the method further comprises: deactivating at lease a transmit and/or receive circuitry required for normal mode operation for the one or more second cells when transmission associated with the one or more second cells is delegated to the first cell. In some embodiments, when the first cell is served by the network node, the method further comprises: receiving a delegated paging message for the terminal device on behalf of a second cell, wherein the method further comprises at least one of: transmitting, to another network node that is serving the second cell, a message to wake up the other network node; and transmitting, to the terminal device, the delegated paging message.

In some embodiments, when the one or more second cells are served by the network node, the method further comprises: receiving, from another network node that is serving the first cell, a message to wake up the network node, wherein the method further comprises at least one of: activating at least a transmit circuitry and initiating transmissions of downlink signals; and activating at least a receive circuitry and initiating reception of PRACH transmissions from a terminal device. In some embodiments, when the first cell is served by the network node, the method further comprises: determining whether a number of paging messages in the first cell is greater than a threshold or not; triggering functions required for processing of terminal device responses to paging messages in another network node, which is serving at least one of the one or more second cells, to be activated.

In some embodiments, the network node comprises at least one of: a gNB-Central Unit (gNB-CU); and a gNB-Distributed Unit (gNB-DU). In some embodiments, when the network node comprises a gNB-CU, the method further comprises: configuring a cell to be a delegated cell or a delegating cell; and transmitting, to a gNB-DU, a message indicating that the cell is a delegated cell or a delegating cell. In some embodiments, when the network node comprises a gNB-DU, the method further comprises: receiving, from a gNB-CU, a message indicating that a cell is a delegated cell or a delegating cell. In some embodiments, the message indicating that the cell is a delegated cell or a delegating cell is transmitted from the gNB-CU to the gNB-DU via one of: an F1 Setup procedure; a gNB-CU Configuration Update procedure; and a paging procedure for a terminal device. In some embodiments, when the network node comprises a first gNB-CU that is serving a delegated cell, the method further comprises at least one of: transmitting, to a gNB-DU that is associated with the first gNB-CU and that is serving a corresponding delegating cell, a paging message for activating the delegating cell via F1 interface; and transmitting, to a second gNB-CU that is serving a corresponding delegating cell, a message for activating the delegating cell via Xn interface when the delegating cell is not served by any gNB-DU associated with the first gNB-CU.

In some embodiments, when the network node comprises a gNB-DU that is serving a delegating cell, the method further comprises: receiving, from a first gNB-CU that is associated with the gNB-DU and that is serving a corresponding delegated cell, a message for activating the delegating cell via F1 interface. In some embodiments, when the network node comprises a second gNB-CU that is serving a delegating cell and that is not serving a corresponding delegated cell, the method further comprises: receiving, from a first gNB-CU that is serving the corresponding delegated cell, a message for activating the delegating cell via Xn interface. In some embodiments, when an indicator indicating that a part of transmission associated with a second cell is delegated to the second cell itself is transmitted or received, the indicator indicates that the part of transmission is not delegated to any cell.

According to a fifth aspect of the present disclosure, a network node is provided. The network node comprises: a processor; a memory storing instructions which, when executed by the processor, cause the processor to perform any of the methods of the fourth aspect.

According to a sixth aspect of the present disclosure, a network node for facilitating a terminal device in selecting a cell for network access is provided. The network node comprises: a transmitting module configured to transmit one or more messages and/or signals indicating one or more configurations for selecting a cell to enable the terminal device to select a cell from multiple cells comprising a first cell and one or more second cells based on at least the one or more configurations, wherein at least a part of transmission associated with the one or more second cells is delegated to the first cell. In some embodiments, the network node comprises one or more further modules, each of which may perform any of the methods of the fourth aspect.

According to a seventh aspect of the present disclosure, a computer program comprising instructions is provided. The instructions, when executed by at least one processor, cause the at least one processor to carry out the method of any of the first or fourth aspect.

According to an eighth aspect of the present disclosure, a carrier containing the computer program of the seventh aspect is provided. The carrier is one of an electronic signal, optical signal, radio signal, or computer readable storage medium.

According to a ninth aspect of the present disclosure, a telecommunication system is provided. The telecommunication system comprises: one or more terminal devices; and at least one network node, wherein at least one of the terminal devices and the at least one network node are configured to transmit, from the at least one network node to the at least one terminal device, one or more messages and/or signals indicating one or more configurations for selecting a cell; and select, by the terminal device, a cell from multiple cells comprising a first cell and one or more second cells based on at least the one or more configurations, wherein at least a part of transmission associated with the one or more second cells is delegated to the first cell.

In some embodiments, the at least one terminal device is a terminal device of the second or third aspect. In some embodiments, the at least one network node is a network node of the fifth or sixth aspect.

With some embodiments of the present disclosure, random access procedures can be distributed over delegating cell and delegated cell in a better manner, and therefore system performance can then be improved. For example, with some embodiments of the present disclosure, the network may be enabled to configure or indicate to the UE on which cell the random access procedure following a paging message should be performed. The cell, towards which the UE initiates the random access procedure, can be selected as required, resulting better load balancing and lowered power consumption.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary telecommunication network in which UEs and gNB may be operated according to an embodiment of the present disclosure.

FIG. 2 shows diagrams illustrating exemplary cell delegation scenarios in which selection of cell for network access according to an embodiment of the present disclosure may be applicable.

FIG. 3 is a diagram illustrating an exemplary procedure for configuring and updating delegating cell information according to an embodiment of the present disclosure.

FIG. 4 is a diagram illustrating an exemplary procedure for facilitating a UE in selecting a cell for network access in a cell delegation scenario according to an embodiment of the present disclosure.

FIG. 5 is a flow chart illustrating an exemplary method at a UE for selecting a cell for network access in a cell delegation scenario according to an embodiment of the present disclosure.

FIG. 6 is a flow chart illustrating an exemplary method at a network node for facilitating a UE in selecting a cell for network access in a cell delegation scenario according to an embodiment of the present disclosure.

FIG. 7 schematically shows an embodiment of an arrangement which may be used in a UE or a network node according to an embodiment of the present disclosure.

FIG. 8 is a block diagram of an exemplary terminal device according to an embodiment of the present disclosure.

FIG. 9 is a block diagram of an exemplary network node according to an embodiment of the present disclosure.

FIG. 10 shows an example of a communication system in accordance with some embodiments of the present disclosure.

FIG. 11 shows an exemplary UE in accordance with some embodiments of the present disclosure.

FIG. 12 shows an exemplary network node in accordance with some embodiments of the present disclosure.

FIG. 13 is a block diagram of an exemplary host, which may be an embodiment of the host of FIG. 10, in accordance with various aspects described herein.

FIG. 14 is a block diagram illustrating an exemplary virtualization environment in which functions implemented by some embodiments may be virtualized.

FIG. 15 shows a communication diagram of an exemplary host communicating via an exemplary network node with an exemplary UE over a partially wireless connection in accordance with some embodiments of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as selection of cell for network access in a cell delegation scenario is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc. Therefore, one skilled in the arts could readily understand that the terms used herein may also refer to their equivalents in any other infrastructure. For example, the term “terminal device” used herein may refer to a UE, a mobile device, a mobile terminal, a mobile station, a user device, a user terminal, a wireless device, a wireless terminal, or any other equivalents. For another example, the term “network node” used herein may refer to a transmission reception point (TRP), a base station, a base transceiver station, an access point, a hot spot, a NodeB, an Evolved NodeB (eNB), a gNB, a network element, or any other equivalents.

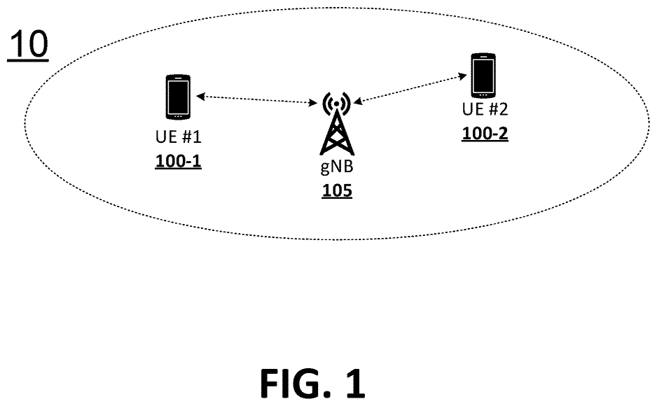

FIG. 1 is a diagram illustrating an exemplary telecommunication network 10 in which a UE #1 100-1, a UE #2 100-2, and a RAN node (e.g., gNB) 105 may be operated according to an embodiment of the present disclosure. Although the telecommunication network 10 is a network defined in the context of 5G NR, the present disclosure is not limited thereto.

As shown in FIG. 1, the network 10 may comprise one or more UEs 100-1 and 100-2 (collectively, UE(s) 100) and a RAN node 105, which could be a base station, a Node B, an evolved NodeB (eNB), a gNB, or an AN node which provides the UEs 100 with access to the network. Further, the network 10 may comprise its core network portion that is not shown in FIG. 1.

However, the present disclosure is not limited thereto. In some other embodiments, the network 10 may comprise additional nodes, less nodes, or some variants of the existing nodes shown in FIG. 1. For example, in a network with the 4G architecture, the entities (e.g., an eNB) which perform these functions may be different from those (e.g., the gNB 105) shown in FIG. 1. For another example, in a network with a mixed 4G/5G architecture, some of the entities may be same as those shown in FIG. 1, and others may be different.

Further, although two UEs 100 and one gNB 105 are shown in FIG. 1, the present disclosure is not limited thereto. In some other embodiments, any number of UEs and/or any number of gNBs may be comprised in the network 10.

As shown in FIG. 1, the UEs 100 may be communicatively connected to the gNB 105 which in turn may be communicatively connected to a corresponding Core Network (CN) and then the Internet, such that the UEs 100 may finally communicate its user plane data with other devices outside the network 10, for example, via the gNB 105.

Recently, energy efficiency optimization of wireless systems has gained significant attention from industry. The network (NW) is expected to be able to smartly switch-off partial components to save energy, while still supporting the UE with necessary capability (e.g., capacity, coverage, etc.)

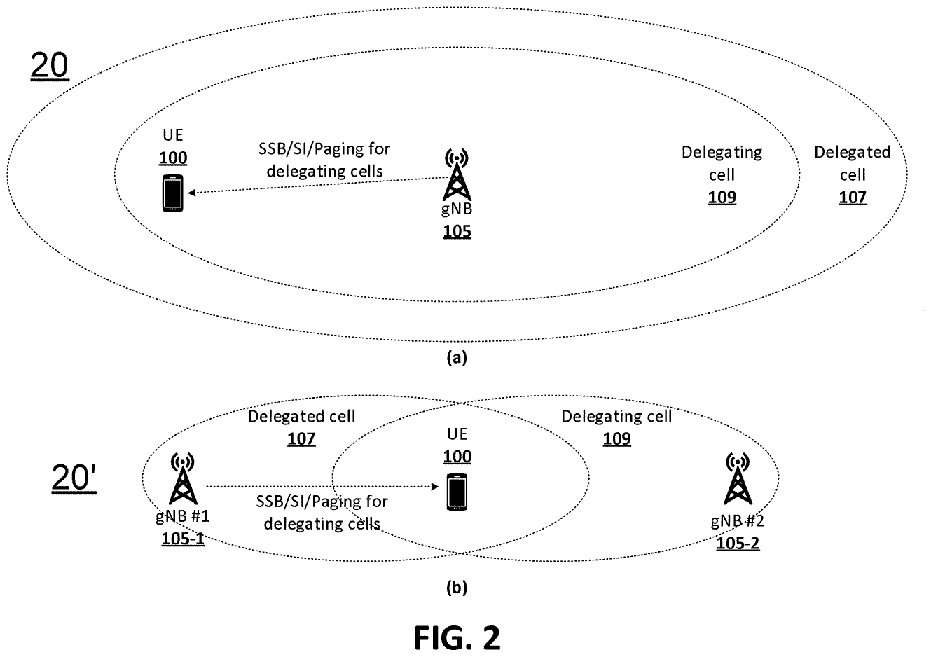

There are many different solutions for network energy savings which can be categorized into e.g. time domain solutions, frequency domain solutions, spatial domain solutions, power domain solutions, node domain solutions, etc. One idea discussed in 3^{rd} Generation Partnership Project (3GPP) is that some cells (called delegating cells) can delegate the transmission of SSB (synchronization signal block) and SI (system information) to other cells (called delegated cells). With this solution, a gNB with a delegating cell can go into deeper sleep states since a delegating cell can have no or very few periodic transmissions. Next, some exemplary cell delegation scenarios will be described with reference to FIG. 2.

FIG. 2 shows diagrams illustrating exemplary cell delegation scenarios in which selection of cell for network access according to an embodiment of the present disclosure may be applicable. As shown in (a) of FIG. 2, a telecommunication network 20 may comprise a gNB 105 and a UE 100. The gNB 105 may serve the UE 100 through multiple cells 107 and 109. As shown in (a) of FIG. 2, transmission associated with the cell 109 can be delegated to the cell 107, and therefore the cell 107 is called as the delegated cell 107 and the cell 109 is called as the delegating cell 109. In some embodiments, at least a part of transmission associated with the delegating cell 109 can be performed in the delegated cell 107 instead of the delegating cell 109 itself when the part of transmission is delegated to the delegated cell 107. For example, some or all of the SSBs/SIs/Pagings that were previously transmitted by the gNB 105 in the frequency resource assigned for the delegating cell 109 now may be transmitted in the frequency resource assigned for the delegated cell 107. In such a case, the gNB 105 may turn off some of its transmitters and/or radio chains used for the delegating cell 109, and its power consumption may be reduced significantly. Further, in some embodiments, the part of transmission associated with the delegating cell 109 may be performed in the delegating cell 109 itself when the part of transmission is not delegated to any cell. In some embodiments, when the part of transmission associated with the delegating cell 109 is not delegated or not to be delegated to any cell, such a fact or request may be signaled from and/or to a node (e.g., the gNB 105) with an indicator indicating that the part of transmission associated with the delegating cell 109 is delegated to the delegating cell 109 itself.

As shown in (b) of FIG. 2, a telecommunication network 20′ may comprise multiple gNBs 105-1 and 105-2 and a UE 100. The multiple gNBs 105-1 and 105-2 may serve the UE 100 through multiple cells 107 and 109, respectively. In some embodiments, at least a part of transmission associated with the delegating cell 109 can be performed in the delegated cell 107 instead of the delegating cell 109 itself when the part of transmission is delegated to the delegated cell 107. In such a case, the gNB #2 105-2 may delegate the transmission of at least one of SSBs/SIs/Pagings for the delegating cell 109 to the gNB #1 105-1 or the delegated cell 107. In such a case, the gNB 105-2 may turn off all of its transmitters and/or radio chains used for the delegating cell 109, and its power consumption may be even further reduced. Further, in some embodiments, the part of transmission associated with the delegating cell 109 may be performed in the delegating cell 109 itself when the part of transmission is not delegated to any cell. In some embodiments, when the part of transmission associated with the delegating cell 109 is not delegated or not to be delegated to any cell, such a fact or request may be signaled from and/or to a node (e.g., the gNB 105-1 and/or the gNB 105-2) with an indicator indicating that the part of transmission associated with the delegating cell 109 is delegated to the delegating cell 109 itself.

One problem with delegating SSB and SI transmissions to another cell is that: as paging messages are then only transmitted from the delegated cell, consequently, the random-access procedure triggered by paging will be carried out on the delegated cell as well.

Even though there are discussions that for UE initiated random access procedure, it is possible that such random-access procedure can be carried on the delegating cell, it is difficult for the UE to do so when it receives a paging message from a delegated cell.

This means that the paging triggered random access procedure is concentrated on the delegated cell which may overload the delegated cell.

Furthermore, if the network intends to wake up the delegating cell and move the UE being paged there, it is inefficient for the UE to first perform a first random-access procedure to the delegated cell in response to the paging message, and then, immediately after the first random-access procedure, perform a second random-access procedure to the (now activated) delegating cell for the purpose of performing a handover. Delegating paging messages to another cell causes additional signalling overhead when the paged UE shall attach to the network, which is inefficient.

When it comes to UE initiated random access procedure, it is not always beneficial to carry out the access on the delegating cell. Certain accesses are only for the purpose of control signalling such as updating the network with UE presence, for example periodical registration updates. Certain other accesses may be associated with very small data exchange that could easily be handled by the delegated cell if the delegated cell is currently under low load. It is unnecessary to wake up the delegating cell just for the sake of small data exchange or registration updates. On the other hand, if the UE initiated access is always performed on the delegated cell, it would not be optimal due to excessive delay caused by wakeup and handover to delegating cell if the connection cannot optimally be handled by the delegated cell, such as cases with high data exchange or when the delegated cell is under heavy load.

In all aspects above, it might even be so that the delegated cell may not be capable of handling certain specific services and those specific services need to be carried out on the delegating cell.

The main idea of a proposed solution in some embodiments is to let the network configure or indicate to the UE on which cell the random access procedure following a paging message should be performed. The cell paging the UE (i.e. the delegated cell) thus informs the UE to respond with a random access procedure targeting another cell (i.e. the delegating cell). Note that the delegated and delegating cells may be operating on the same carrier or on different carriers. When the delegating and delegated cells operate on the same carrier, they may have disjunct, partly overlapping, or perfectly overlapping bandwidth parts (BWPs).

In some embodiments, the UE may be further configured with which cell should perform the UE-initiated random access procedure. The configuration could in some embodiments be conditioned on certain criteria fulfilment.

In some embodiments, in the split NG-RAN architecture, a gNB-CU communicates to a gNB-DU (in the same or different NG-RAN node) the “delegating cell” or the cell that preferred to be used to serve the UE. In some embodiments, the gNB-CU may choose the cell based on the Mobile Terminated service.

In some embodiments, when UE is paged, gNB-CU may activate the “delegating cell” or the preferred cell to serve the UE, if the cell is early deactivated. Further, in some embodiments, gNB-CU may appoint to the SSBs to be activated.

In some embodiments, gNB-CU may choose the delegating cells based on the knowledge of their network energy information, e.g. the cell DTRX information; the strategy to either distribute the load or concentrate the load, for the best performance and network energy saving purpose. In some embodiments, gNB-CU may also use the slicing information and/or UE capability to determine the delegating cells/serving cells.

In some embodiments, a method in a mobile terminal for receiving broadcast or dedicated configuration, or an L1/L2 indication such as a Downlink Control Information (DCI) or a paging PDSCH from the network may be provided. In some embodiments, said configuration may inform the UE on which of a first, second, or another cell it should establish connection in response to paging and/or upon a UE-initiated random access procedure.
In some embodiments, said configuration may contain criteria for in what cases the UE should carry out the access on first, second, or another cell.
In some embodiments, said criteria could for example be one or more of:
   A specific establishment cause (e.g., emergency, highPriorityAccess, mt-Access, mo-Signalling, mo-Data, mo-VoiceCall, mo-VideoCall, mo-SMS, mps-PriorityAccess, mcs-PriorityAccess). E.g., for mo-Data, the UE shall initiate access on a first cell, whereas for mo-VoiceCall, the UE shall initiate access on a second cell, etc.
   A specific radio bearer. E.g., for certain radio bearers the UE accesses the first cell, whereas for certain other radio bearers the UE accesses the second cell
   A specific data threshold. E.g., when current data buffer or foreseen data exchange rate for a service exceeds a certain threshold, the UE performs the access on the second cell.
   A specific RNTI used in the paging message. E.g., different cells are specified to be used for access depending on whether the UE is paging with a P-RNTI compared to when the UE is paged using another RNTI (e.g., a group-specific RNTI)
   A specific indication in a bitfield or value tag or a sequence in one or more of SSB, SIB or a specific RS.

In some embodiments, a method in a mobile terminal for receiving a paging message from a first cell is provided, said paging message (or an associated signal e.g., paging early indicator (PEI), or wake-up signal (WUS) or alike) containing an indication that said mobile terminal shall (irrespective of potential preconfigured conditions in the other method above) perform a random-access procedure towards the first or a second cell, in response to receiving the paging message.

In some embodiments, a method for reducing network energy consumption by delegating the transmission of paging messages from a second network node comprising a second cell to a first network node comprising a first cell may be provided. The method may further comprise the optional steps of:
Said second node enters a deep sleep mode where the transmission of paging messages is delegated to said first node. Said deep sleep mode is characterized by at least some transmit or receive circuitry required for normal mode operation is deactivated.
Said first node receives a delegated paging message to be transmitted to a UE on behalf of said second node and
   sends a message (e.g. wake-up signal) to said second node.
   sends said delegated paging message to said UE.
When receiving said message from said first node the second node exits said deep sleep mode by performing at least one of the following steps:
   activation of some transmit circuitry and initiating transmissions of a downlink signal (e.g. an SSB, a CSI-RS, a synchronization signal, etc.) and/or
   activating some receive circuitry and initiating reception of PRACH transmissions corresponding to said delegated paging message.
Said second node receives a PRACH transmission related to said delegated paging message and start to serve said UE.

In some embodiments, the first cell may activate paging reception in a second cell based on the current paging load. E.g. when the number of paging messages in the first cell is above a threshold, the first cell may activate functions required for processing of UE responses to paging messages in a second cell (e.g. activating transmission of SSB and/or activation of PRACH reception in a second cell).

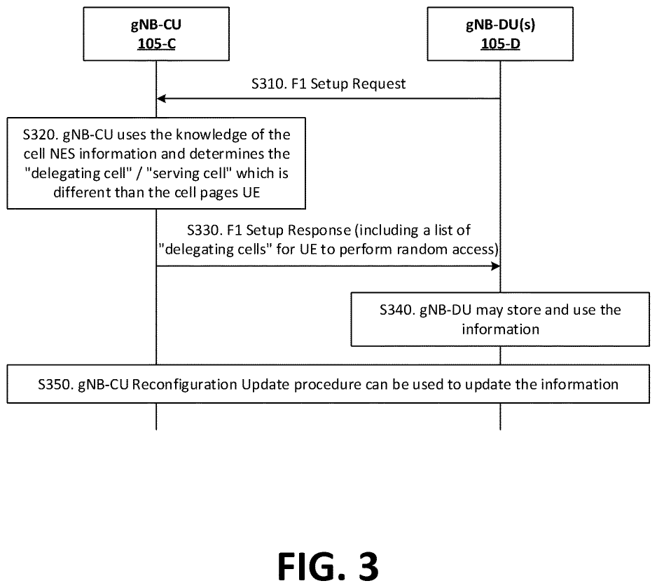

In some embodiments, the gNB-CU may configure the cell to be the delegated cells and communicate to gNB-DU; the gNB-CU may configure the cell to be the delegating cells and communicate to gNB-DU, either via F1 setup procedure, or gNB-CU configuration update procedure, for example, as shown in FIG. 3.

FIG. 3 is a diagram illustrating an exemplary procedure for configuring and updating delegating cell information according to an embodiment of the present disclosure. FIG. 3 shows an example of a gNB-CU 105-C including the “delegating cell” information for the delegated cells in gNB-DU 105-D in the F1AP procedures.

As shown in FIG. 3, a gNB-DU 105-D may initiate an F1 Setup procedure with a gNB-CU 105-C by transmitting, to the gNB-CU 105-C, an F1 Setup Request message at step S310. At step S320, the gNB-CU 105-C may use the knowledge of the cell network energy saving (NES) information and determine the “delegating cell”/“serving cell” which is different than the cell that pages UEs. At step S330, the gNB-CU 105-C may respond to the request message received at step S310 with an F1 Setup Response message that comprises a list of “delegating cells” for UEs to perform random access. At step S340, the gNB-DU 105-D may store and use the received information (e.g., the list of delegating cells) for subsequent use. Later, the gNB-CU 105-C may update the information (e.g., the list of delegating cells) by a gNB-CU Reconfiguration Update procedure as shown at step S350.

In some embodiments, the gNB-CU may configure the cell to be the delegated cells and communicate to gNB-DU, via paging procedure, for the dedicated UE.

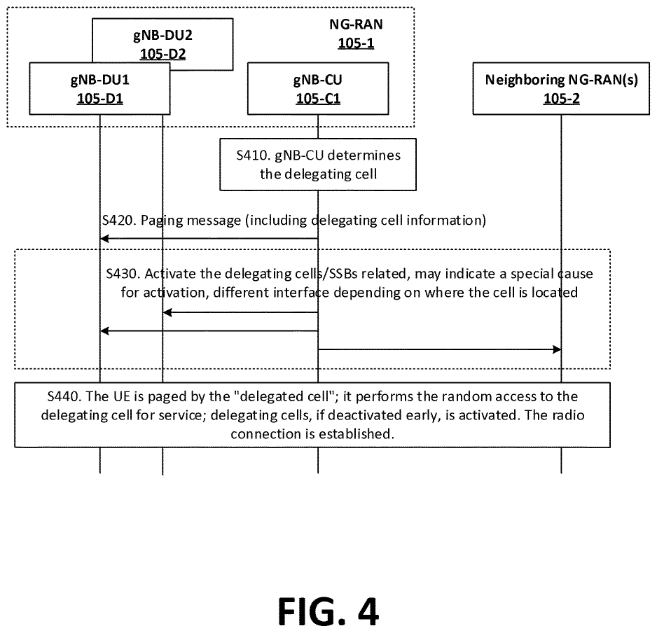

In some embodiments, the gNB-CU may configure the cell to be the delegating cells and communicate to gNB-DU, via paging procedure, for the dedicated UE. At the same time, gNB-CU may also activate the “delegating cells”, if they are deactivated early, via F1 interface for its cells under the gNB-CU, or via Xn interface, if the delegating cells belong to the neighbouring NG-RAN node, for example, as shown in FIG. 4.

FIG. 4 is a diagram illustrating an exemplary procedure for facilitating a UE in selecting a cell for network access in a cell delegation scenario according to an embodiment of the present disclosure. FIG. 4 shows a gNB-CU 105-C1 including the delegating cells to a gNB-DU 105-D1 in a Paging procedure. In some embodiments, the gNB-CU 105-C1 may wake up the related delegating cell/SSB if they are deactivated. In some embodiments, a special “wake up” cause could be used to indicate the purpose, so the receiver may prioritize.

As shown in FIG. 4, a gNB-CU 105-C1 associated with a NG-RAN node (e.g., a gNB) 105-1 may determine the delegating cell at step S410, for example, upon arrival of a paging message for a UE. At step S420, the gNB-CU 105-C1 may transmit, to a gNB-DU1 105-D1 that is serving a delegated cell corresponding to the determined delegating cell, the paging message for the UE together with the information for the delegating cell. Depending on which node serves the determined delegating cell (the gNB-DU1 105-D1, another gNB-DU2 105-D2 that also belongs to the same NG-RAN node 105-1 as the gNB-DU1 105-D1 does, or a different (e.g., neighboring) NG-RAN node 105-2), the gNB-CU 105-C1 may activate the delegating cell at step S430. In some embodiments, the message for activation may indicate a special cause for activation, for example, to indicate that the activation of the delegating cell is caused by a paging message in the delegated cell. At step S440, the UE may be paged by the delegated cell, and it may perform the random access to the delegating cell for service. If the delegating cells were deactivated early, then they can be activated now. Finally, a radio connection between the UE and the delegating cell can be established.

In some embodiments, the delegating cell and the delegated cell may be preconfigured. When there is a need to signal the new configurations, the preconfigured settings may be overwritten.

With some embodiments of the present disclosure, random access procedures can be distributed over delegating cell and delegated cell in an optimal manner. System performance can then be improved.

As mentioned above, cells in the system can have different roles regarding SSB, SI, and Paging transmission. Some cells can delegate their SSB/SI/Paging transmission to other cells so that there are no or very few periodic transmissions in the cells and then gNB can go to deeper sleep state to save power.

Different from the SCell in Carrier Aggregation concept, such delegating cell can still have the capability of random access. This is because UE still can obtain SSB and SI of those cells from delegated cell. Based on such information, UE can initiate random access procedure on delegating cells even though it does not receive such information from delegating cells directly.

However, there is no discussion about how to handle the random-access procedure either triggered by Paging message or initiated by the UE itself.

In the above scenario, similar as SSB and SI, paging message can be only transmitted from delegated cells as well. According to current specification, paging message just indicate which UEs are paged. See NR paging message below from TS 38.331, v16.5.0.

-- ASN1START
-- TAG-PAGING-START

| | |
|---|---|
| Paging ::= | SEQUENCE { |
| pagingRecordList | PagingRecordList |

OPTIONAL, -- Need N

| | |
|---|---|
| lateNonCriticalExtension | OCTET STRING |

OPTIONAL,

| | |
|---|---|
| nonCriticalExtension | SEQUENCE{ } |

OPTIONAL
}

| | |
|---|---|
| PagingRecordList ::= | SEQUENCE (SIZE(1..maxNrofPageRec)) OF PagingRecord |
| PagingRecord ::= | SEQUENCE { |
| ue-Identity | PagingUE-Identity, |
| accessType | ENUMERATED {non3GPP} OPTIONAL, -- Need N |

...
}

| | |
|---|---|
| PagingUE-Identity ::= | CHOICE { |
| ng-5G-S-TMSI | NG-5G-S-TMSI, |
| fullI-RNTI | I-RNTI-Value, |

...
}
-- TAG-PAGING-STOP
-- ASN1STOP

Then according to current spec, UE shall initiate the following random access procedure on the cell (and carrier) where it receives Paging, i.e. delegated cell.

Similarly, for mobile originated access (UE-initiated access) the UE initiates the random access procedure on the current serving cell where the UE is receiving its paging and SI.

When quite a few cells/carriers delegating its SSB/SI Paging transmission toward other delegated cells/carriers, the random access load on delegated cells/carrier can be quite high and thus system performance will be degraded. Furthermore, as highlighted above, even if the random access is carried out on the delegated cell, it is not always that the delegated cell can fully carry out the service for the UE on the delegated cell. For example, the delegated cell may perhaps be currently overloaded, or the current cell may for example not be capable of certain specific services (e.g., perhaps not capable of Voice over NR VoNR) and therefore would need to wake up the delegating cell and handover the connection to the delegating cell resulting in delays. On the other hand, it might not always be optimal for the UE to initiate the connection on the delegating cell. For example, for certain short data transmission or for certain control signalling related communication such as periodic registration updates, it is unnecessary to wake up the delegating cell from sleep in case the delegated cell can handle the connection.

In some embodiments, to solve this issue, it is better to let network inform UE which cell/carrier the UE shall initiate random access procedure either when it is UE initiated (mobile originated) or when it is mobile terminated, i.e., when it receives such paging message.

In some embodiments, the UE may be preconfigured (provided with dedicated/broadcast configuration earlier) in which it is described through which cell the UE carries out the random access procedure. The broadcast configuration may be provided at any point in time. E.g., a bitfield or value tag in MIB, or a specific sequence in SSB or another RS, or a bitfield or value tag in a SIB, e.g., SIB1 can indicate if the UE should transmit random response on delegating or delegated cell. E.g., a value tag may be configured in SIB1, where if the value is 1, the UE is then indicated to transmit random response to paging on the delegated cell, and if 0 on the delegating cell. Other combinations are also possible, e.g., a bitmap, or a codepoint referring exactly to the cell where the response should be transmitted to, e.g., 4 cells may be configured for the UE of which one is a delegated cell and 3 are delegating cells, and then a bitmap of 4 bits or a codepoint of 2 bits can refer which cell should be the receiver of random response. E.g., a codepoint of 11 indicates to the UE that the random response should be sent to the delegated cell, while other combinations indicate which of the delegating cells the UE should transmit the random response. The configuration of the bitfield or value tag or sequence can be part of the higher layer signalling, or pre-configuration according to standardization documentations.

In some embodiments, the dedicated configuration may overrule potential broadcast configuration. In a related embodiment, the dedicated configuration may be accompanied with a validity timer and/or area, and only during the duration of said timer and/or while within the defined area the dedicated configuration is valid. In some embodiments, the UE may receive the dedicated signalling/configuration either from the delegated cell or delegating cell, e.g., while in connected mode.

In some embodiments, the configurations may specify different cells for random access depending on whether the establishment is due to paging response or UE initiated access.

In some embodiments, different cells may be configured for random access for different establishment causes. E.g., in current specifications the UE may perform connection establishment via random access due to one of the following establishment causes:

EstablishmentCause ::= ENUMERATED {emergency, highPriorityAccess, mt-Access, mo-Signalling,
mo-Data, mo-VoiceCall, mo-VideoCall, mo-SMS, mps-PriorityAccess, mcs-PriorityAccess,...)

In some embodiments, the network may then specify one or more cells associated with the different establishment causes that lie behind the random access initiation. For example, for mt-access (i.e., paging response), and mo-signaling (e.g., registration area update) the delegated cell shall be accessed whereas for the other establishment causes the delegating cell shall be accessed by the UE.

In some embodiments, different cells may be specified for specific actions. E.g., the UE may have been configured to access through the delegated cell in case the registration update is of type periodic registration update, but not otherwise.

In some embodiments, different cells may be configured for access depending on which radio bearer or QoS flow or 5QI the access is related to.

In some embodiments, different cells may be configured for access depending on certain specific criteria related to data exchange rate/size. E.g., a threshold may be configured for a specific establishment cause/bearer/5QI/etc. and only if the currently buffered UL data or foreseen/expected data during a certain time or throughout the expected connection exceeds said threshold the UE performs the establishment on one cell and on the other cell otherwise.

In some embodiments, the UE may be configured to initiate the access on one cell if the paging message is encoded with a certain RNTI (e.g. P-RNTI) vs. if the message is encoded with another RNTI (e.g. a group RNTI).

In some embodiments, indicator in the paging message may be provided. These embodiments may coexist with previous ones where UE is preconfigured with where to carry out the access. However, in case of coexistence with previous methods, the indicator below may potentially override earlier provided configuration.
1) Add some bits in Paging message to indicate the cell/carrier that the following random access procedure should be executed. The number of bits needed depends on the number of cells/carriers this delegated carrier is responsible for, for example, 1 bit for one delegating cell/carrier, 2 bits for up to 4 delegating cells/carriers. That is, the network may indicate explicitly on which cell/carrier to perform this paging triggered random access procedure. The UE may just follow the explicit instructions of the network.
2) Add one bit in Paging message indicate that the cell/carrier that the following random access procedure should be executed is for delegating cell/carrier. Then UE has the flexibility to initiate random access procedure on any delegating cell/carrier. For example, when this bit is included, it may indicate that the random access procedure shall be on any delegating carrier, the UE randomly select one of the delegating carrier for following random access procedure.

In some embodiments, a change of PDCCH scrambled with P-RNTI may be provided.

Since paging message can also be carried in PDCCH scrambled with P-RNTI, as shown below.

Short Messages

| Bit | Short Message |
|---|---|
| 1 | systemInfoModification |
| | If set to 1: indication of a BCCH modification other than SIB6, SIB7 and SIB8. |
| 2 | etwsAndCmasIndication |
| | If set to 1: indication of an ETWS primary notification and/or an ETWS secondary notification and/or a CMAS notification. |
| 3 | stopPagingMonitoring |
| | This bit can be used for only operation with shared spectrum channel access and if nrofPDCCH-MonitoringOccasionPerSSB-InPO is present. |
| | If set to 1: indication that the UE may stop monitoring PDCCH occasion(s) for paging in this Paging Occasion as specified in TS 38.304 [20], |
| | clause 7.1. |
| 4-8 | Not used in this release of the specification, and shall be ignored by UE if received. |

In some other embodiments, a PDCCH may be changed to include some information.
3) Use the reserved bits 4-8 in PDCCH to indicate which cell/carrier should be used for the following random access procedure. Two variants may be provided as above either
3.1 that explicitly indicate which cell/carrier to use, but then maximum delegating carrier is 4 or
3.2 just indicate paging should be carried on delegating cell/carrier, but which one is left for UE implementation, then just one bit is enough. In some embodiments, other messages that are associated with paging could also be used for the said indicator above. For example the Paging Early Indicator (PEI) or similar wakeup signal associated with the paging message could also carry such indicator.

As such, in some embodiments, the UE may receive a configuration of a delegated cell and one or more delegating cells, and furthermore it may be configured e.g., by higher layer signaling or pre-configuration such that a bitfield in the paging message, either DCI or paging PDSCH is configured that the bitfield indicates to the UE where the random response should be transmitted to.

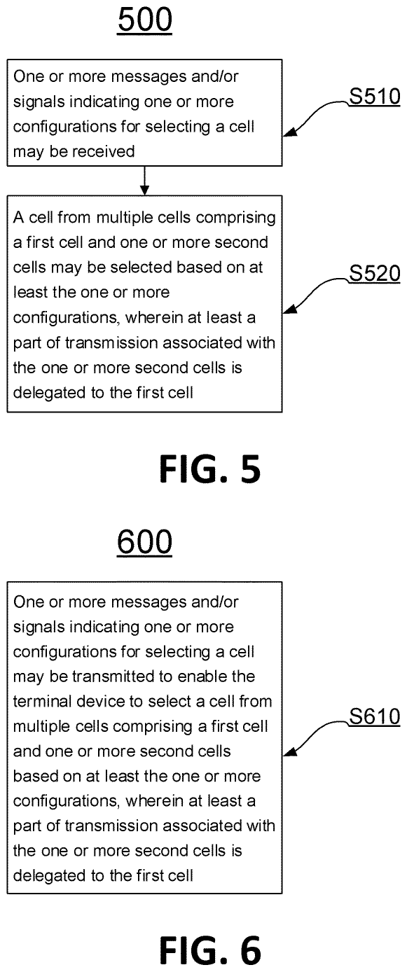

FIG. 5 is a flow chart of an exemplary method 500 at a terminal device for selecting a cell for network access according to an embodiment of the present disclosure. The method 500 may be performed at a terminal device (e.g., the UE 100). The method 500 may comprise steps S510 and S520. However, the present disclosure is not limited thereto. In some other embodiments, the method 500 may comprise more steps, less steps, different steps, or any combination thereof. Further the steps of the method 500 may be performed in a different order than that described herein when multiple steps are involved. Further, in some embodiments, a step in the method 500 may be split into multiple sub-steps and performed by different entities, and/or multiple steps in the method 500 may be combined into a single step.

The method 500 may begin at step S510 where one or more messages and/or signals indicating one or more configurations for selecting a cell may be received.

At step S520, a cell from multiple cells comprising a first cell and one or more second cells may be selected based on at least the one or more configurations, wherein at least a part of transmission associated with the one or more second cells may be delegated to the first cell.

In some embodiments, the multiple cells may be associated with one or more network nodes. In some embodiments, the part of transmission associated with the one or more second cells may be performed in the first cell instead of the one or more second cells, when the part of transmission is delegated to the first cell, and/or the part of transmission associated with the one or more second cells may be performed in the one or more second cells, when the part of transmission is not delegated to any cell. In some embodiments, the method 500 may further comprise: initiating a random access procedure towards the selected cell.

In some embodiments, before the step of selecting the cell, the method 500 may further comprise: receiving, from the first cell, a paging message destined to the terminal device, wherein the step of selecting the cell may be performed in response to the step of receiving, from the first cell, a paging message destined to the terminal device. In some embodiments, the one or more messages and/or signals may comprise at least one of: a Radio Resource Control (RRC) Master Information Block (MIB) message; an RRC System Information Block 1 (SIB1) message; an RRC System Information (SI) message; an RRC paging message; a Medium Access Control (MAC) Protocol Data Unit (PDU); a MAC Control Element (CE); a paging Physical Downlink Shared Channel (PDSCH); a Physical Downlink Control Channel (PDCCH); a Synchronous Signal and Physical Broadcast Channel Block (SSB); and a Reference Signal (RS).

In some embodiments, for at least one of the second cells, at least one of following may be delegated to the first cell: SSB transmission associated with the at least one second cell; SIB1 transmission associated with the at least one second cell; SI transmission associated with the at least one second cell; and paging associated with the at least one second cell. In some embodiments, at least one of the one or more messages may be received from at least one of: the first cell; and at least one of the one or more second cells. In some embodiments, the one or more configurations may comprise at least one of: a dedicated configuration that is dedicated to the terminal device and indicates towards which cell the terminal device is to initiate a random access procedure; and a broadcast configuration that is broadcast to the terminal device and indicates towards which cell a terminal device is to initiate a random access procedure.

In some embodiments, at least one of the one or more configurations may indicate towards which cell the terminal device is to initiate a random access procedure by at least one of: an Information Element (IE); a bitfield; a value tag; and a specific sequence. In some embodiments, when a dedicated configuration for cell selection and a broadcast configuration for cell selection are received by the terminal device, the broadcast configuration may be overruled by the dedicated configuration. In some embodiments, when the one or more messages indicate a dedicated configuration, the one or more messages may further indicate a validity timer and/or a validity area, such that the dedicated configuration is valid for the terminal device only during a time duration indicated by the validity timer and/or only when the terminal device is located in the validity area. In some embodiments, at least one of the one or more configurations may indicate that different cells from the multiple cells are to be selected for access due to different trigger events. In some embodiments, the trigger events may comprise at least one of: paging; and terminal device initiated access.

In some embodiments, at least one of the one or more configurations may indicate that different cells from the multiple cells are to be selected for access with different establishment causes. In some embodiments, at least one of the one or more configurations may indicate that different cells from the multiple cells are to be selected for access with different action purposes. In some embodiments, at least one of the one or more configurations may indicate that different cells from the multiple cells are to be selected for access with at least one of different radio bearers, different Quality of Service (QoS) flows, and different 5G QoS Identifiers (5QIs). In some embodiments, at least one of the one or more configurations may indicate that different cells from the multiple cells are to be selected for access with different requirements on data exchange. In some embodiments, the different requirements on data exchange may comprise at least one of: data exchange rate; and data exchange size.

In some embodiments, when the one or more messages comprise a paging message, the step of selecting the cell may comprise: selecting different cells from the multiple cells for access in response to the paging message being encoded with different Radio Network Temporary Identifiers (RNTIs). In some embodiments, when the one or more messages comprise a paging message, a configuration for cell selection indicated by the paging message may override any other configuration for cell selection that is received prior to the paging message. In some embodiments, when the one or more messages may comprise a paging message, a configuration for cell selection indicated by the paging message may explicitly indicate towards which cell a random access procedure is to be initiated by the terminal device, wherein the step of selecting the cell may comprise: selecting the cell indicated by the paging message. In some embodiments, when the one or more messages comprise a paging message, a configuration for cell selection indicated by the paging message may indicate whether the first cell or one of the second cells is to be selected for access, wherein the step of selecting the cell may comprise at least one of: selecting the first cell in response to the paging message indicating that the first cell is to be selected; and selecting one of the second cells in response to the paging message indicating that one of the second cells is to be selected for access. In some embodiments, the step of selecting one of the second cells may comprise: randomly selecting one of the second cells. In some embodiments, the one or more messages may comprise a PDCCH scheduling a short message. In some embodiments, when an indicator indicating that a part of transmission associated with a second cell is delegated to the second cell itself is transmitted or received, the indicator may indicate that the part of transmission is not delegated to any cell.

FIG. 6 is a flow chart of an exemplary method 600 at a network node for facilitating a terminal device in selecting a cell for network access according to an embodiment of the present disclosure. The method 600 may be performed at a network node (e.g., the gNB 105, 105-1, or 105-2). The method 600 may comprise a step S610. However, the present disclosure is not limited thereto. In some other embodiments, the method 600 may comprise more steps, different steps, or any combination thereof. Further the steps of the method 600 may be performed in a different order than that described herein when multiple steps are involved. Further, in some embodiments, a step in the method 600 may be split into multiple sub-steps and performed by different entities, and/or multiple steps in the method 600 may be combined into a single step.

The method 600 may begin at step S610 where one or more messages and/or signals indicating one or more configurations for selecting a cell may be transmitted to enable the terminal device to select a cell from multiple cells comprising a first cell and one or more second cells based on at least the one or more configurations, wherein at least a part of transmission associated with the one or more second cells may be delegated to the first cell.

In some embodiments, the multiple cells may be associated with one or more network nodes comprising the network node. In some embodiments, the part of transmission associated with the one or more second cells may be performed in the first cell instead of the one or more second cells, when the part of transmission is delegated to the first cell, and/or wherein the part of transmission associated with the one or more second cells may be performed in the one or more second cells, when the part of transmission is not delegated to any cell. In some embodiments, the method 600 may further comprise: receiving, from the terminal device, a Physical Random Access Channel (PRACH) transmission for the selected cell. In some embodiments, before the step of receiving, from the terminal device, the PRACH transmission, the method 600 may further comprise: transmitting, to the terminal device, a paging message, wherein the step of receiving, from the terminal device, the PRACH transmission may be performed in response to the step of transmitting, to the terminal device, a paging message.

In some embodiments, the one or more messages and/or signals may comprise at least one of: a Radio Resource Control (RRC) Master Information Block (MIB) message; an RRC System Information Block 1 (SIB1) message; an RRC System Information (SI) message; an RRC paging message; a Medium Access Control (MAC) Protocol Data Unit (PDU); a MAC CE; a paging Physical Downlink Shared Channel (PDSCH); a Physical Downlink Control Channel (PDCCH); a Synchronous Signal and Physical Broadcast Channel Block (SSB); and a Reference Signal (RS). In some embodiments, for at least one of the second cells, at least one of following may be delegated to the first cell: SSB transmission associated with the at least one second cell; SIB1 transmission associated with the at least one second cell; SI transmission associated with the at least one second cell; and paging associated with the at least one second cell.

In some embodiments, the network node may serve at least one of: the first cell; and at least one of the one or more second cells. In some embodiments, the one or more configurations may comprise at least one of: a dedicated configuration that is dedicated to the terminal device and indicates towards which cell the terminal device is to initiate a random access procedure; and a broadcast configuration that is broadcast to the terminal device and indicates towards which cell a terminal device is to initiate a random access procedure. In some embodiments, at least one of the one or more configurations may indicate towards which cell the terminal device is to initiate a random access procedure by at least one of: an Information Element (IE); a bitfield; a value tag; and a specific sequence. In some embodiments, when a dedicated configuration for cell selection and a broadcast configuration for cell selection are transmitted to the terminal device, the broadcast configuration may be overruled by the dedicated configuration.

In some embodiments, when the one or more messages indicate a dedicated configuration, the one or more messages may further indicate a validity timer and/or a validity area, such that the dedicated configuration may be valid for the terminal device only during a time duration indicated by the validity timer and/or only when the terminal device is located in the validity area. In some embodiments, at least one of the one or more configurations may indicate that different cells from the multiple cells are to be selected by the terminal device for access due to different trigger events. In some embodiments, the trigger events may comprise at least one of: paging; and terminal device initiated access.

In some embodiments, at least one of the one or more configurations may indicate that different cells from the multiple cells are to be selected by the terminal device for access with different establishment causes. In some embodiments, at least one of the one or more configurations may indicate that different cells from the multiple cells are to be selected by the terminal device for access with different action purposes. In some embodiments, at least one of the one or more configurations may indicate that different cells from the multiple cells are to be selected by the terminal device for access with at least one of different radio bearers, different Quality of Service (QoS) flows, and different 5G QoS Identifiers (5QIs). In some embodiments, at least one of the one or more configurations may indicate that different cells from the multiple cells are to be selected by the terminal device for access with different requirements on data exchange. In some embodiments, the different requirements on data exchange may comprise at least one of: data exchange rate; and data exchange size.

In some embodiments, when the one or more messages may comprise a paging message, a configuration for cell selection indicated by the paging message may indicate that different cells from the multiple cells are to be selected by the terminal device based on at least different Radio Network Temporary Identifiers (RNTIs), with which the paging message is encoded. In some embodiments, when the one or more messages comprise a paging message, a configuration for cell selection indicated by the paging message may override any other configuration for cell selection that is transmitted prior to the paging message. In some embodiments, when the one or more messages comprise a paging message, a configuration for cell selection indicated by the paging message may explicitly indicate towards which cell a random access procedure is to be initiated by the terminal device, wherein the step of receiving the PRACH transmission for the selected cell may comprise: receiving, from the terminal device, the PRACH transmission for the cell indicated by the paging message.

In some embodiments, when the one or more messages comprise a paging message, a configuration for cell selection indicated by the paging message may indicate whether the first cell or one of the second cells is to be selected by the terminal device for access, wherein the step of receiving the PRACH transmission for the selected cell may comprise at least one of: receiving, from the terminal device, the PRACH transmission for the first cell in response to the paging message indicating that the first cells is to be selected by the terminal device for access; and receiving, from the terminal device, the PRACH transmission for one of the second cells in response to the paging message indicating that one of the second cells is to be selected by the terminal device for access. In some embodiments, the second cell, for which the PRACH transmission is received, may be randomly selected from the one or more second cells.

In some embodiments, the one or more messages may comprise a PDCCH scheduling a short message. In some embodiments, when the one or more second cells are served by the network node, the method 600 may further comprise: deactivating at lease a transmit and/or receive circuitry required for normal mode operation for the one or more second cells when transmission associated with the one or more second cells is delegated to the first cell. In some embodiments, when the first cell is served by the network node, the method 600 may further comprise: receiving a delegated paging message for the terminal device on behalf of a second cell, wherein the method 600 may further comprise at least one of: transmitting, to another network node that is serving the second cell, a message to wake up the other network node; and transmitting, to the terminal device, the delegated paging message.

In some embodiments, when the one or more second cells are served by the network node, the method 600 may further comprise: receiving, from another network node that is serving the first cell, a message to wake up the network node, wherein the method 600 may further comprise at least one of: activating at least a transmit circuitry and initiating transmissions of downlink signals; and activating at least a receive circuitry and initiating reception of PRACH transmissions from a terminal device. In some embodiments, when the first cell is served by the network node, the method 600 may further comprise: determining whether a number of paging messages in the first cell is greater than a threshold or not; triggering functions required for processing of terminal device responses to paging messages in another network node, which is serving at least one of the one or more second cells, to be activated.

In some embodiments, the network node may comprise at least one of: a gNB-Central Unit (gNB-CU); and a gNB-Distributed Unit (gNB-DU). In some embodiments, when the network node comprises a gNB-CU, the method 600 may further comprise: configuring a cell to be a delegated cell or a delegating cell; and transmitting, to a gNB-DU, a message indicating that the cell is a delegated cell or a delegating cell. In some embodiments, when the network node comprises a gNB-DU, the method 600 may further comprise: receiving, from a gNB-CU, a message indicating that a cell is a delegated cell or a delegating cell. In some embodiments, the message indicating that the cell is a delegated cell or a delegating cell may be transmitted from the gNB-CU to the gNB-DU via one of: an F1 Setup procedure; a gNB-CU Configuration Update procedure; and a paging procedure for a terminal device. In some embodiments, when the network node comprises a first gNB-CU that is serving a delegated cell, the method 600 may further comprise at least one of: transmitting, to a gNB-DU that is associated with the first gNB-CU and that is serving a corresponding delegating cell, a paging message for activating the delegating cell via F1 interface; and transmitting, to a second gNB-CU that is serving a corresponding delegating cell, a message for activating the delegating cell via Xn interface when the delegating cell is not served by any gNB-DU associated with the first gNB-CU.

In some embodiments, when the network node comprises a gNB-DU that is serving a delegating cell, the method 600 may further comprise: receiving, from a first gNB-CU that is associated with the gNB-DU and that is serving a corresponding delegated cell, a message for activating the delegating cell via F1 interface. In some embodiments, when the network node comprises a second gNB-CU that is serving a delegating cell and that is not serving a corresponding delegated cell, the method 600 may further comprise: receiving, from a first gNB-CU that is serving the corresponding delegated cell, a message for activating the delegating cell via Xn interface. In some embodiments, when an indicator indicating that a part of transmission associated with a second cell is delegated to the second cell itself is transmitted or received, the indicator may indicate that the part of transmission is not delegated to any cell.

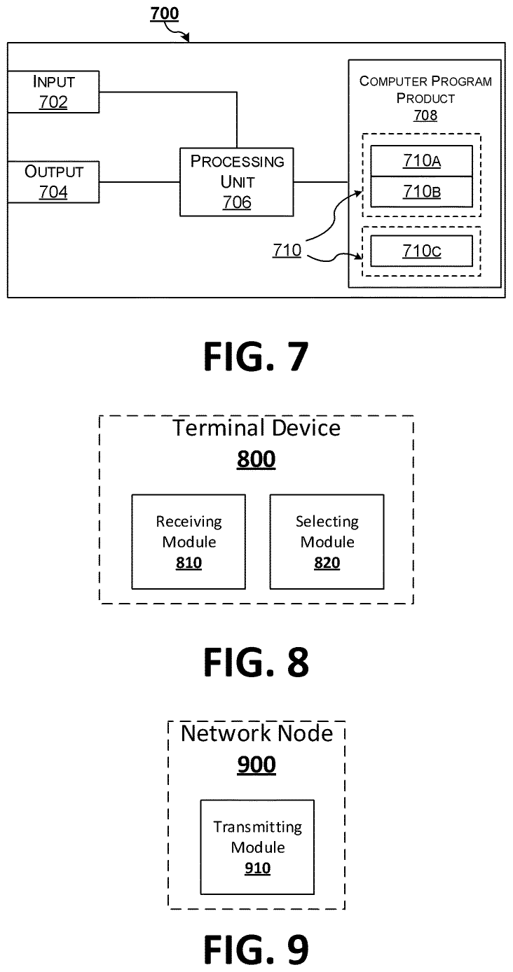

FIG. 7 schematically shows an embodiment of an arrangement 700 which may be used in a terminal device (e.g., the UE 100) or a network node (e.g., the gNB 105, 105-1, 105-2) according to an embodiment of the present disclosure. Comprised in the arrangement 700 are a processing unit 706, e.g., with a Digital Signal Processor (DSP) or a Central Processing Unit (CPU). The processing unit 706 may be a single unit or a plurality of units to perform different actions of procedures described herein. The arrangement 700 may also comprise an input unit 702 for receiving signals from other entities, and an output unit 704 for providing signal(s) to other entities. The input unit 702 and the output unit 704 may be arranged as an integrated entity or as separate entities.

Furthermore, the arrangement 700 may comprise at least one computer program product 708 in the form of a non-volatile or volatile memory, e.g., an Electrically Erasable Programmable Read-Only Memory (EEPROM), a flash memory and/or a hard drive. The computer program product 708 comprises a computer program 710, which comprises code/computer readable instructions, which when executed by the processing unit 706 in the arrangement 700 causes the arrangement 700 and/or the terminal device/network node in which it is comprised to perform the actions, e.g., of the procedure described earlier in conjunction with FIG. 3 through FIG. 6 or any other variant.

The computer program 710 may be configured as a computer program code structured in computer program modules 710A and 710B. Hence, in an exemplifying embodiment when the arrangement 700 is used in a terminal device, the code in the computer program of the arrangement 700 includes: a module 710A configured to receive one or more messages and/or signals indicating one or more configurations for selecting a cell; and a module 710B configured to select a cell from multiple cells comprising a first cell and one or more second cells based on at least the one or more configurations, wherein at least a part of transmission associated with the one or more second cells is delegated to the first cell.

Further, the computer program 710 may be further configured as a computer program code structured in a computer program module 710C. Hence, in an exemplifying embodiment when the arrangement 700 is used in a network node, the code in the computer program of the arrangement 700 includes: a module 710C configured to transmit one or more messages and/or signals indicating one or more configurations for selecting a cell to enable the terminal device to select a cell from multiple cells comprising a first cell and one or more second cells based on at least the one or more configurations, wherein at least a part of transmission associated with the one or more second cells is delegated to the first cell.

The computer program modules could essentially perform the actions of the flow illustrated in FIG. 3 through FIG. 6, to emulate the terminal device or the network node. In other words, when the different computer program modules are executed in the processing unit 706, they may correspond to different modules in the terminal device or the network node.

Although the code means in the embodiments disclosed above in conjunction with FIG. 7 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the terminal device and/or the network node.

Correspondingly to the method 500 as described above, an exemplary terminal device is provided. FIG. 8 is a block diagram of a terminal device 800 according to an embodiment of the present disclosure. The terminal device 800 may be, e.g., the UE 100 in some embodiments.

The terminal device 800 may be configured to perform the method 500 as described above in connection with FIG. 5. As shown in FIG. 8, the terminal device 800 may comprise: a receiving module 810 configured to receive one or more messages and/or signals indicating one or more configurations for selecting a cell; and a selecting module 820 configured to select a cell from multiple cells comprising a first cell and one or more second cells based on at least the one or more configurations, wherein at least a part of transmission associated with the one or more second cells may be delegated to the first cell.

The above modules 810 and/or 820 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5. Further, the terminal device 800 may comprise one or more further modules, each of which may perform any of the steps of the method 500 described with reference to FIG. 5.

Correspondingly to the method 600 as described above, a network node is provided. FIG. 9 is a block diagram of an exemplary network node 900 according to an embodiment of the present disclosure. The network node 900 may be, e.g., the gNB 105, 105-1, or 105-2 in some embodiments.

The network node 900 may be configured to perform the method 600 as described above in connection with FIG. 6. As shown in FIG. 9, the network node 900 may comprise a transmitting module 910 configured to transmit one or more messages and/or signals indicating one or more configurations for selecting a cell to enable the terminal device to select a cell from multiple cells comprising a first cell and one or more second cells based on at least the one or more configurations, wherein at least a part of transmission associated with the one or more second cells may be delegated to the first cell.

The above module 910 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 6. Further, the network node 900 may comprise one or more further modules, each of which may perform any of the steps of the method 600 described with reference to FIG. 6.

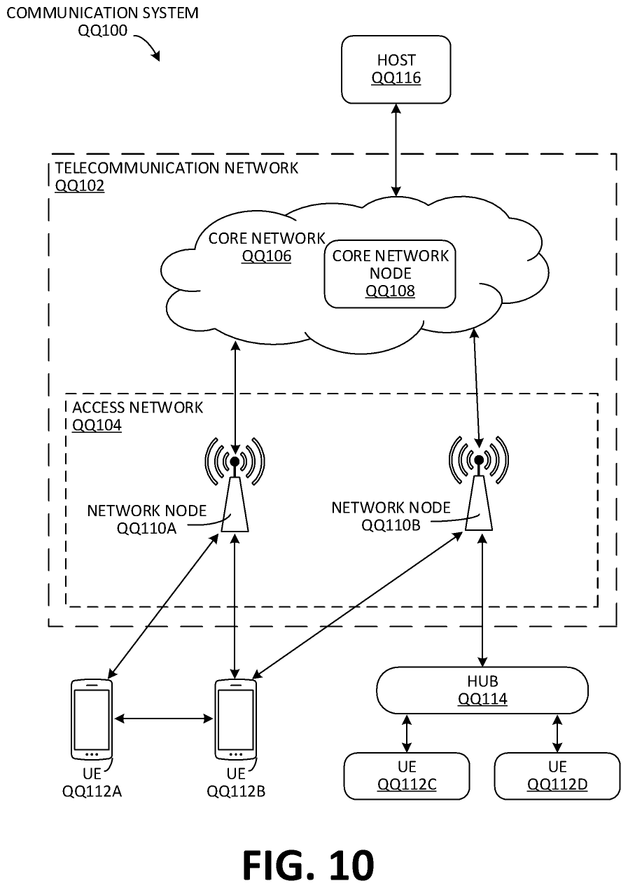

FIG. 10 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

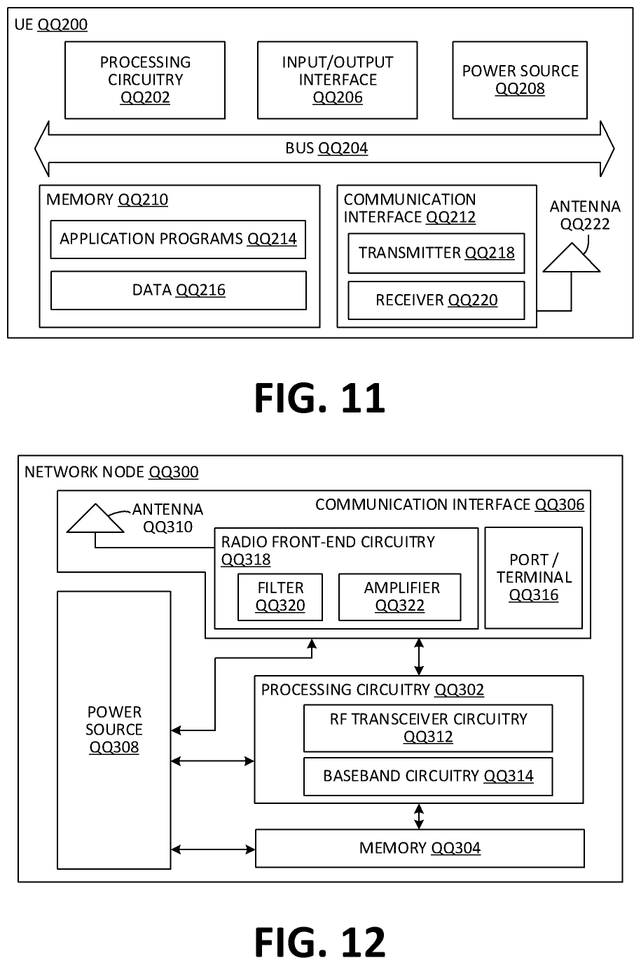

FIG. 11 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 12 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

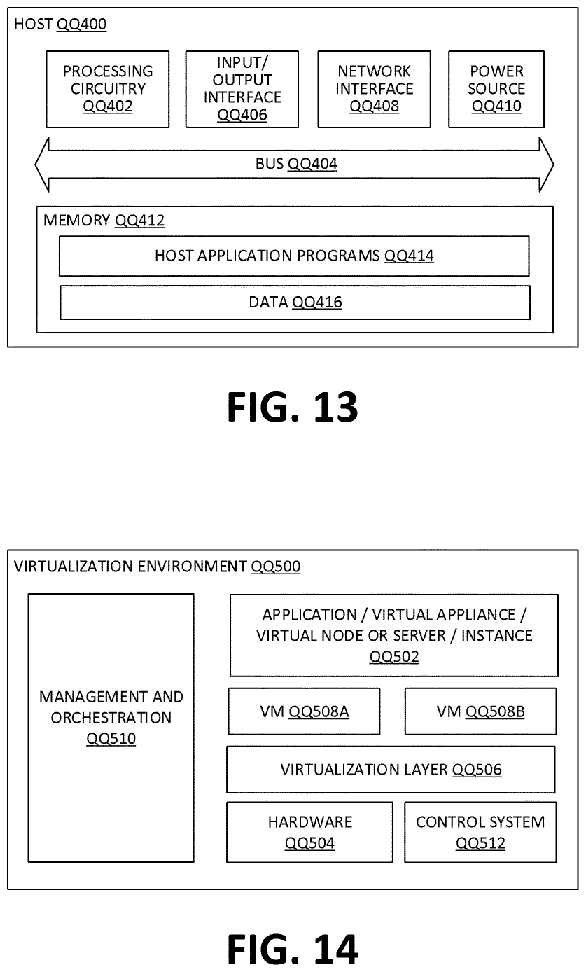

FIG. 13 is a block diagram of a host QQ400, which may be an embodiment of the host QQ116 of FIG. 10, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIG. 11 and FIG. 12, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

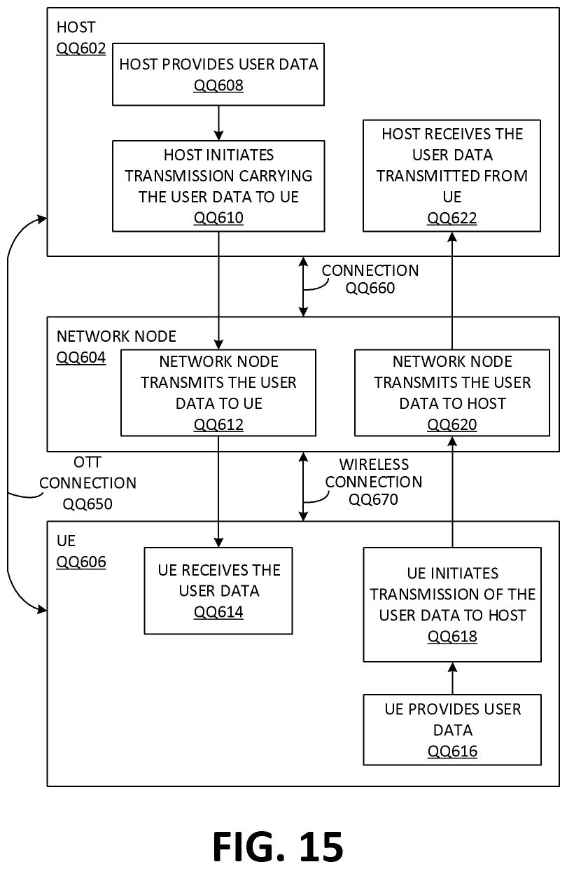

FIG. 15 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 10 and/or UE QQ200 of FIG. 11), network node (such as network node QQ110a of FIG. 10 and/or network node QQ300 of FIG. 12), and host (such as host QQ116 of FIG. 10 and/or host QQ400 of FIG. 13) discussed in the preceding paragraphs will now be described with reference to FIG. 15.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 10) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1-70. (canceled)

71. A method at a terminal device for selecting a cell for network access, the method comprising:
receiving one or more messages and/or signals indicating one or more configurations for selecting a cell; and
selecting a cell from multiple cells comprising a first cell and one or more second cells based on at least the one or more configurations, wherein at least a part of transmission associated with the one or more second cells is delegated to the first cell.

72. The method of claim 71, wherein the part of transmission associated with the one or more second cells is performed in the first cell instead of the one or more second cells, when the part of transmission is delegated to the first cell, and/or wherein the part of transmission associated with the one or more second cells is performed in the one or more second cells, when the part of transmission is not delegated to any cell.

73. The method of claim 71, wherein before the step of selecting the cell, the method further comprises:
receiving, from the first cell, a paging message destined to the terminal device, and wherein the step of selecting the cell is performed in response to the step of receiving, from the first cell, a paging message destined to the terminal device.

74. The method of claim 71, wherein the one or more configurations comprise at least one of:
a dedicated configuration that is dedicated to the terminal device and indicates towards which cell the terminal device is to initiate a random access procedure; and
a broadcast configuration that is broadcast to the terminal device and indicates towards which cell a terminal device is to initiate a random access procedure.

75. The method of claim 71, wherein at least one of the one or more configurations indicates towards which cell the terminal device is to initiate a random access procedure by at least one of:
an Information Element (IE);
a bitfield;
a value tag; and
a specific sequence.

76. The method of claim 71, wherein when a dedicated configuration for cell selection and a broadcast configuration for cell selection are received by the terminal device, the broadcast configuration is overruled by the dedicated configuration.

77. The method of claim 71, wherein when the one or more messages indicate a dedicated configuration, the one or more messages further indicate a validity timer and/or a validity area, such that the dedicated configuration is valid for the terminal device only during a time duration indicated by the validity timer and/or only when the terminal device is located in the validity area.

78. The method of claim 71, wherein at least one of the one or more configurations indicates that different cells from the multiple cells are to be selected for access due to different trigger events.

79. The method of claim 78, wherein the trigger events comprise at least one of:
paging; and
terminal device initiated access.

80. The method of claim 71, wherein at least one of the one or more configurations indicates that different cells from the multiple cells are to be selected for access with different establishment causes.

81. The method of claim 71, wherein when the one or more messages comprise a paging message, the step of selecting the cell comprises:
selecting different cells from the multiple cells for access in response to the paging message being encoded with different Radio Network Temporary Identifiers (RNTIs).

82. The method of claim 71, wherein when the one or more messages comprise a paging message, a configuration for cell selection indicated by the paging message overrides any other configuration for cell selection that is received prior to the paging message.

83. The method of claim 71, wherein when the one or more messages comprise a paging message, a configuration for cell selection indicated by the paging message explicitly indicates towards which cell a random access procedure is to be initiated by the terminal device, and wherein the step of selecting the cell comprises:
selecting the cell indicated by the paging message.

84. A terminal device, comprising:
a processor;
a memory storing instructions which, when executed by the processor, cause the processor to:
receive one or more messages and/or signals indicating one or more configurations for selecting a cell; and
select a cell from multiple cells comprising a first cell and one or more second cells based on at least the one or more configurations, wherein at least a part of transmission associated with the one or more second cells is delegated to the first cell.

85. A method at a network node for facilitating a terminal device in selecting a cell for network access, the method comprising:
transmitting one or more messages and/or signals indicating one or more configurations for selecting a cell to enable the terminal device to select a cell from multiple cells comprising a first cell and one or more second cells based on at least the one or more configurations;
wherein at least a part of transmission associated with the one or more second cells is delegated to the first cell.

86. The method of claim 85, wherein the part of transmission associated with the one or more second cells is performed in the first cell instead of the one or more second cells, when the part of transmission is delegated to the first cell, and/or wherein the part of transmission associated with the one or more second cells is performed in the one or more second cells, when the part of transmission is not delegated to any cell, or when the part of transmission is delegated to the one or more second cells.

87. The method of claim 85, further comprising receiving, from the terminal device, a Physical Random Access Channel (PRACH) transmission for the selected cell.

88. The method of claim 87, wherein before the step of receiving, from the terminal device, the PRACH transmission, the method further comprises:
transmitting, to the terminal device, a paging message;
wherein the step of receiving, from the terminal device, the PRACH transmission is performed in response to the step of transmitting, to the terminal device, a paging message.

89. The method of claim 85, wherein the one or more messages and/or signals comprise at least one of:
a Radio Resource Control (RRC) Master Information Block (MIB) message;
an RRC System Information Block 1 (SIB1) message;
an RRC System Information (SI) message;
an RRC paging message;
a Medium Access Control (MAC) Protocol Data Unit (PDU);
a MAC CE;
a paging Physical Downlink Shared Channel (PDSCH);
a Physical Downlink Control Channel (PDCCH);
a Synchronous Signal and Physical Broadcast Channel Block (SSB); and
a Reference Signal (RS).

90. The method of claim 85, wherein for at least one of the second cells, at least one of following is delegated to the first cell:
SSB transmission associated with the at least one second cell;
SIB1 transmission associated with the at least one second cell;
SI transmission associated with the at least one second cell; and
paging associated with the at least one second cell.
